(19) United States
(12) Patent Application Publication
(10) Pub. No.: US 2018/0090012 A1
(43) Pub. Date: Mar. 29, 2018

(54) METHODS AND SYSTEMS FOR UNMANNED AIRCRAFT SYSTEMS (UAS) TRAFFIC MANAGEMENT

(71) Applicant: THE BOARD OF REGENTS OF THE NEVADA SYSTEM OF HIGHER EDUCATION ON BEHALF OF THE UNIVERSITY OF, Las Vegas, NV (US)

(72) Inventors: Juyeon Jo, Las Vegas, NV (US); Yoohwan Kim, Las Vegas, NV (US)

(21) Appl. No.: 15/565,267

(22) PCT Filed: Apr. 11, 2016
(86) PCT No.: PCT/US16/26923

§ 371 Date: Oct. 9, 2017

Related U.S. Application Data
(60) Provisional application No. 62/145,953, filed on Apr. 10, 2015.

(51) Int. Cl. G08G 5/00; B64C 39/02

(52) U.S. Cl. CPC G08G 5/0013; B64C 39/024; G08G 5/0091; G08G 5/0034; G08G 5/0026

(57) ABSTRACT

Provided are methods comprising transmitting an authentication request for an operator of an unmanned aircraft system (UAS) to an UAS Traffic Management (UTM) server, transmitting flight plan data to the UTM server if the authentication request is successful, receiving operational data that comprises first traffic data, displaying at least a portion of the operational data, receiving flight data from the UAS, transmitting the flight data to the UTM server, and receiving updated operational data comprising second traffic data based on the flight data.

### CROSS-REFERENCE TO RELATED APPLICATIONS

This application claims the benefit of U.S. Provisional Application No. 62/145,953, filed on Apr. 10, 2015, which is incorporated herein by reference in its entirety.

### BACKGROUND

Due to high affordability and easy controllability, the use of unmanned aircraft systems (UASs) and small unmanned aircraft systems (sUASs) is growing rapidly. Integrating such an increasing number of UASs into the national airspace system (NAS) is a difficult task. Although the regulations limits UASs to class G airspace (under 1200 feet) or below 400 feet for a recreational purpose, UASs are capable of flying high enough to threaten manned aircraft. Accordingly, traffic management of UASs and sUASs is a significant safety issue. The methods and systems disclosed herein address these and other shortcomings of the prior art.

### SUMMARY

It is to be understood that both the following general description and the following detailed description are exemplary and explanatory only and are not restrictive.

In an aspect, provided are methods comprising transmitting an authentication request for an operator of an unmanned aircraft system (UAS) to an UAS Traffic Management (UTM) server, transmitting flight plan data to the UTM server if the authentication request is successful, receiving operational data that comprises first traffic data, displaying at least a portion of the operational data, receiving flight data from the UAS, transmitting the flight data to the UTM server, and receiving updated operational data comprising second traffic data based on the flight data.

In another aspect, provided are methods comprising receiving an authentication request for an operator of an unmanned aircraft system (UAS) from a user device, determining an operator profile associated with the operator, receiving flight plan data from the user device, generating operational data based on the flight plan data, the operator profile, and first traffic data, transmitting the operational data to the user device, receiving flight data from the user device, generating updated operational data based on the flight data, the operator profile, and second traffic data, and transmitting the updated operational data.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary operating environment;

FIG. 2 is an example data flow for system operation;

FIG. 3 is an example user interface;

FIG. 4 is an example user interface;

FIG. 5 is an example user interface;

FIG. 6 is an example user interface;

FIG. 7 is an example user interface;

FIG. 8 is a flowchart illustrating an example method;

FIG. 9 is a flowchart illustrating an example method; and

FIG. 10 is an exemplary operating environment.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Provided are methods and systems that enable safe and efficient low-altitude airspace operations via a UAS Traffic Management (UTM) system. The UTM system can provide one or more services such as traffic control for UAS, coordination among the UAS and manned aircrafts, restricted flight zone information, weather information, route planning assistance, contingency management upon incidents, combinations thereof, and the like. The disclosed UTM system enables the accelerated development and use of UASs. The UTM system disclosed herein can provide communication, navigation, and surveillance (CNS) to track conformance of the UASs in a coverage region of the UTM system. UAS and sUAS are used herein interchangeable.

The UTM methods and systems disclosed can comprise one or more computing devices acting as one or more UTM servers accessible via a network (e.g., a cloud server). In an aspect, disclosed is a user device (e.g., smartphone, laptop, tablet, and the like) which can be deployed in the field to support one or more UASs. The user device can manage multiple UASs and can relay communications from the UASs to the one or more UTM servers via the network. The UTM server can communicate with an Air Traffic Management (ATM) controller as well as other UASs, can authorize a flight of one or more UASs, can coordinate one or more flights continuously throughout the flight, can enable two-way real-time communication with a UAS operator and the ATM controller, can maintain a national database of active UASs, combinations thereof, and the like.

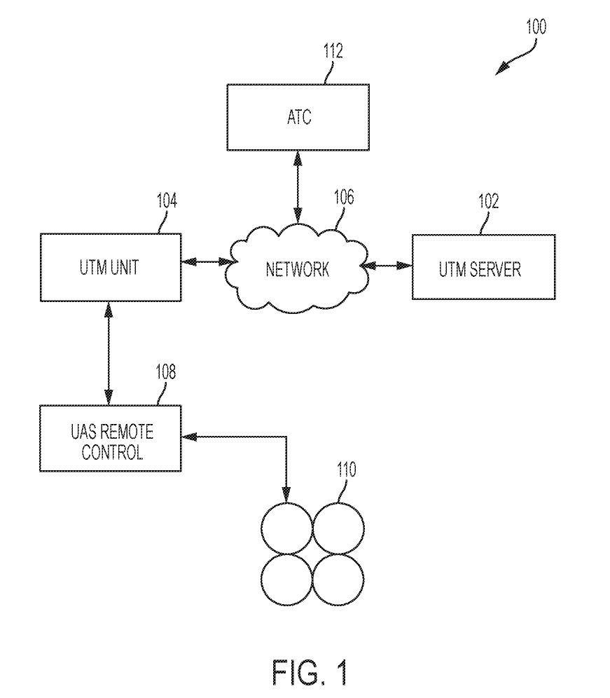

In an aspect, illustrated in FIG. 1, provided is a UTM system 100 that can comprise one or more UTM servers 102 and one or more UTM units 104. The UTM server 102 can be a computing device. The UTM server 102 can be configured to support a cloud computing data structure. The UTM unit 104 (e.g., user device) can be an electronic device such as a computer, a smartphone, a laptop, a tablet, or other device capable of communicating with the UTM server 102. In an aspect, the UTM unit 104 can be integrated into a UAS 110. The UTM unit 104 can comprise a persistent UTM unit 104 which supports low-altitude operations and provides continuous coverage for a geographical area or the UTM unit 104 can be portable. The UTM server 102 and the UTM unit 104 can be in communication via a network 106 (private and/or public) such as the Internet or a local area network. Other forms of communications can be used such as wired and wireless telecommunication channels, for example. The UTM server 102 can communicate one or more Air Traffic Control (ATC) controllers 112 via the network 106.

The UTM unit 104 can be in communication with one or more UAS remote controls 108. The one or more UAS remote controls 108 can be any electronic device configured for sending and receiving data and for controlling operation of one or more UASs 110. The one or more UASs 110 can comprise any unmanned vehicle purposed for flight, including for example, unmanned aircraft devices (UAD), small Unmanned Aircraft Systems (sUASs), small Unmanned Aircraft Devices (sUADs), small unmanned aerial vehicles (sUAVs), and unmanned aerial vehicles (UAVs). The weight classification of the one or more UASs 110 can vary (e.g., a small or micro). For example, in one aspect a micro UAS 110 is defined as a device less than 4.5 pounds. In another aspect, a small or micro UAS 110 can weigh between 3 pounds (1.4 kg) and 11.0 pounds (5 kg.). An example structure of the one or more UASs 115 can comprise a quad-copter style, however, alternative structures are contemplated.

The UTM unit 104 can be configured to receive data from the UAS remote control 108 (or directly from one or more UASs 110). For example, the UTM unit 104 can be configured to receive flight data from the UAS remote control 108. Flight data can comprise position data. Position data can comprise current position, heading, speed, and the like. For example, the UAS 110 can be equipped with a positioning system such as a GPS. In an aspect, the position data can comprise GPS coordinates. The UAS 110 can transmit the positioning data obtained via the positioning system to the UAS remote control 108. The UAS remote control 108 can transmit the position data to the UTM unit 104.

The UTM unit 104 can be configured to communicate data to and from the UTM server 102. The UTM unit 104 can be configured to transmit the flight data to the UTM server 102. The UTM unit 104 can permit an operator of the UAS 110 to enter flight plan data into the UTM 104 for transmission to the UTM server 102. Flight plan data can comprise, for example, data related to an anticipated flight of the UAS 110. For example the flight plan data can comprise one or more of, a flight purpose (commercial vs. recreational), a current location, a flight path/pattern, a flight area, a flight time, a flight duration, combinations thereof, and the like.

The UTM server 102 can be configured to authorize a flight, coordinate the flight continuously throughout the flight, enable real-time two-way communication with the operator and the ATC controller 112, and maintain a database of active UASs 115. The UTM server 102 provides UAS traffic management functionality. The UTM server 102 can be configured to manage an airspace. By way of example, the UTM server 102 can manage an airspace defined by a privacy-protected area map. The UTM server 102 can maintain a real-time database of one or more UAS locations. The UTM server 102 can obtain and store weather and hazard-related data to transmit to the UTM unit 104. The UTM server 102 can interact with the ATC controller 112, also referred to as an air traffic control management device. The UTM server 102 can provide a web service for access by the general public.

The UTM server 102 can transmit operational data, such as weather data, traffic data, privacy data, combinations thereof, and the like, to the UTM unit 104. Weather data can comprise data related to any weather condition that can impact flight of the UAS 110. Traffic data can comprise any data related to activity of the UAS 110, other UASs, manned aircraft, combination thereof, and the like. The UTM server 102 can be configured to continuously receive flight data from UASs in the vicinity to update the traffic data. Communication can be established with the ATC 112 to provide traffic data to the ATC 120 and/or receive traffic data from the ATC 112. Privacy data can comprise any data related to an area within which UAS activity is restricted or otherwise banned. The UTM server 102 can generate operational data from one or more data sources. In an aspect, the UTM server 102 can utilize an operator profile to generate operational data. The operator profile can comprise data related to the operator and specifications of the UAS 110. In an aspect, the operator can create the operator profile via a registration process completed via the UTM unit 104 and/or any computing device with network access. The operator profile can comprise one or more of, UAS operator name, UAS owner name, phone number, email address, application identifier, user identifier, registered UAS type, UAS weight, UAS size, MAC address, operating radio frequencies (for control, telemetry, and video), combinations thereof, and the like. In an aspect, the UTM server 102 can utilize the flight plan data to generate operational data. In an aspect, the UTM server 102 can utilize the flight data to generate operational data. In a further aspect, the UTM server 102 can utilize one or more operator profiles, flight plan data, and flight data obtained from a plurality of operators operating UASs in an area.

The operator can thus make a decision about flight activity based on the operational data. The flight data of the UAS 110 can be reported (e.g., periodically) to the UTM server 102 and updated operational data can be received (e.g., periodically) from the UTM server 102.

The functionality provided by the UTM unit 104 allows a user to implement various capabilities. For example, after receiving operational data from the UAS server 102 on the UTM unit 104, the operator can modify a flight path of the UAS 115 appropriately. If the area is indicated as a privacy-protected region, the operator can avoid flying in that region based on the operational data.

In an aspect, an application programming interface (API) can be used to allow other devices/software to interface with the UTM server 102 via a web service. Table 1 provides an example list of coding verbiage for use in the API.

TABLE 1
List of Sample sUTM function API

| HTTP | | |
|---|---|---|
| Method | URL | Description |
| POST | /users | Create a new user. |
| GET | /users/{user_id} | Get a user by user ID |
| PUT | /users/{user_id} | Update the information of a user |
| GET | /users/{user_id}/uavs | Get all of a user's registered |
| | | UASs |
| POST | /users/{user_id}/uavs | Register a new UAS |
| GET | /users/{user_id}/uavs/{u as_id} | Get a user's UAS by UAS ID |
| PUT | /users/{user_id}/uavs/{u as_id} | Update information of a user's |
| | | UAS |
| DELETE | /users/{user_id}/uavs/{u as_id} | Delete a user's UAS |
| GET | /users/{user_id}/flight- plans | Get all of a user's flight plans |
| POST | /users/{user_id}/flight- plans | Create a new flight plan |
| GET | /users/{user_id}/flight- | Get a user's flight plan by flight |
| | plans/{flight_plan_id} | plan ID |
| PUT | /users/{user_id}/flight- | Update the information of a flight |
| | plans/{flight_plan_id} | plan |
| DELETE | /users/{user_id}/flight- | Delete a flight plan |
| | plans/{flight_plan_id} | |
| GET | /uavs | Get all UASs that match the |
| | | given criteria |
| GET | /uavs/{uas_id} | Get a UAS by UAS ID |
| GET | /flight-plans | Get flight plans that match the |
| | | given criteria |
| GET | /flight-plans/{flight_plan_id} | Get a flight plan by flight plan ID |

The web service can use, for example, a Representational State Transfer (REST) software architectural style, implemented using Hypertext Transfer Protocol (HTTP). In this implementation, standard HTTP methods, such as “GET”, “POST”, “PUT”, and “DELETE”, indicate what the device or application using the web service wants to do with an object that is associated with a URL. The HTTP methods can be thought of as “functions” that act on an object that is associated with a URL. Because the web service can implement the REST style using HTTP, the available functions in the API for the web service can be in the form of unique HTTP method and URL combinations, as shown in Table 1.

In Table 1, the acronym “UAV” (Unmanned Aerial Vehicle) is used in the URLs, instead of “UAS”. The word “user” is used to refer to a registered UAS operator. Additionally, the URLs can be relative to a domain name for the web service. For example, if the domain name of the web service is “api.example.com”, the full URL for “/users” can be “api.example.com/users”. The parts of the URLs in Table 1 that are between the braces (“{” and “}”) indicate parts of the URL that can be provided by a device or an application using the web service. In other words, the brackets can act as placeholders for actual values in the URLs. For example, the “/users/{user_id}” URL can be “/users/123” if “123” is a system-generated ID of the user to be accessed.

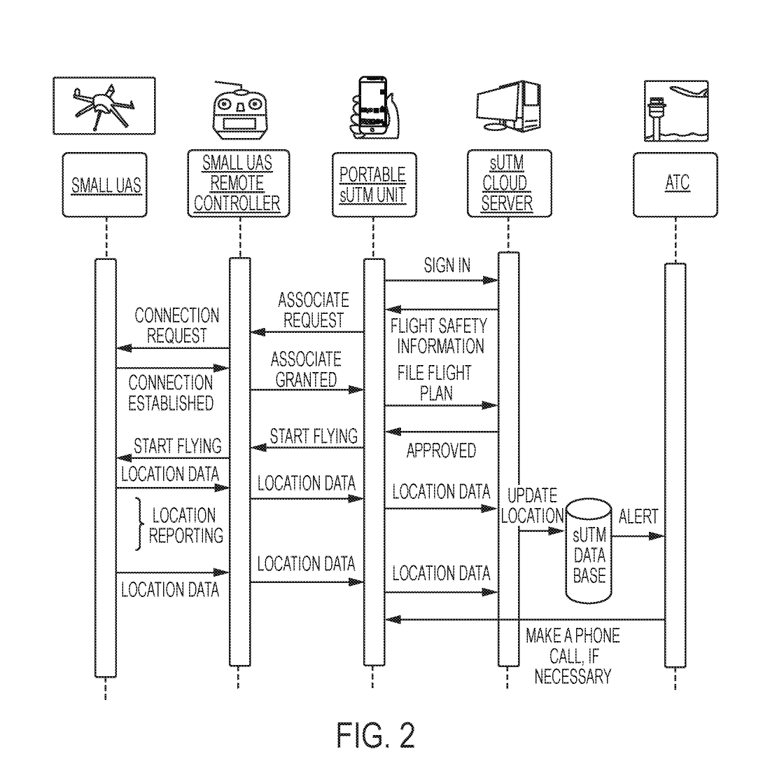

FIG. 2 illustrates an example data flow among components of the UTM system 100. The operator can sign into the UTM unit 104, establishing communications with the UTM server 102. The UTM server 102 can provide initial operational data such as flight safety information to the UTM unit 104 based on the operator profile and/or the location of the UTM unit 104.

The UTM unit 104 can transmit a request to be associated with the UAS remote control 205. Once the request is accepted, the UAS remote control 205 can communicate with the UTM unit 104. In another aspect, the UAS remote control 205 can be physically coupled to the UTM unit 104.

A connection and/or calibration request can be completed between the UAS remote control 108 and the UAS 110. Once the connection/calibration request is approved, a connection between the UAS 110 and the UAS remote control 108 can be established. Accordingly, the operator can manipulate the UAS 110 using the UAS remote control 108.

The operator can enter flight plan data for an anticipated flight into the UTM unit 104. The UTM unit 104 can transmit the flight plan data to the UTM server 102. The UAS server 102 can make a determination whether the anticipated flight by the operator is an approved flight. The flight plan data can be compared to traffic data, and a determination can be made by the UAS server 102. If it is determined that the anticipated flight is approved (e.g., a number of UASs in the area has not exceeded a threshold, current weather conditions do not pose a threat of damage to the UAS or other aircraft or structures, no conflict is found with manned aircraft activities, the flight path does not include a restricted airspace, the operator is in good standing, etc. . . . ), the UTM server 102 can transmit an approval to the UTM unit 104. Otherwise, the UTM server 102 can transmit a denial to the UTM unit 104. In the case of a denial, the operator can receive a warning about legal ramifications if the flight were to commence.

If the flight is approved, the UTM server 102 can transmit operational data to the UTM unit 104 with the approval. After flight has commenced, the previously established connections between the UAS 110 and the UAS remote control 108 and between the UAS remote control 108 to the UTM unit 104 enables current flight data to be transmitted to the UTM server 102. During the flight of the UAS 110, the flight data can be periodically (e.g., continuously) provided to the UTM server 102. The UTM server 102 can continuously monitor the flight of the UAS 110 relative to the flight plan data and flight data of other UASs in the vicinity. In an aspect, the vicinity can be a geographic region (e.g. 0.5 square miles 1 square mile, 5 square miles, etc.) definable at the UTM unit 104. The UTM server 102 can send updated operational data to the UTM unit 104 as needed.

The UTM server 102 can provide flight plan data, traffic data, and/or flight data to the ATC 112. In the event the ATC 112 determines that a change in flight plan is required, the ATC 112 or other authority for Air Traffic Management can monitor and establish communications with the operator. For example, the operator of the UAS 110 can be contacted by cellular phone, text message, email, or smartphone app software implementing the UTM unit 104 functionality.

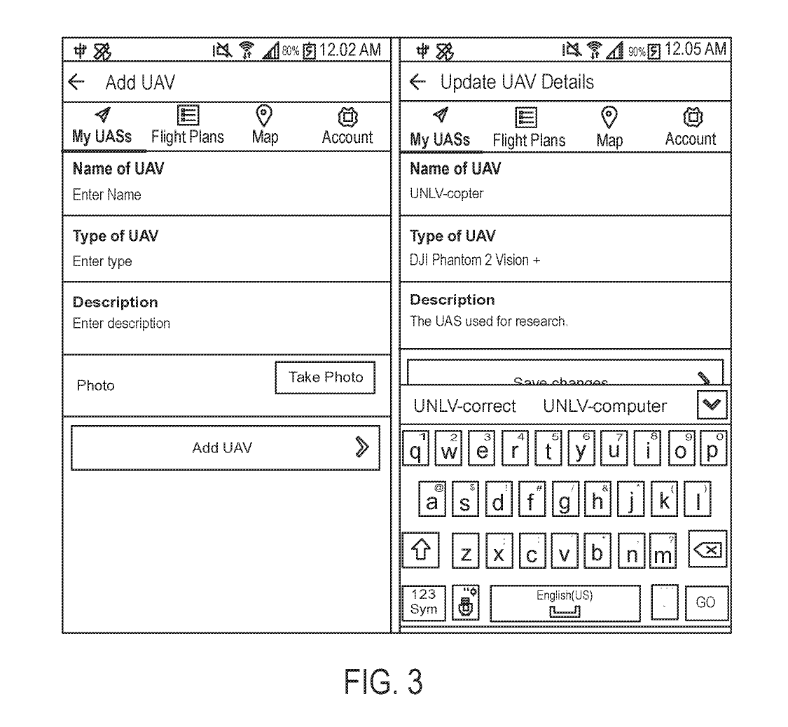

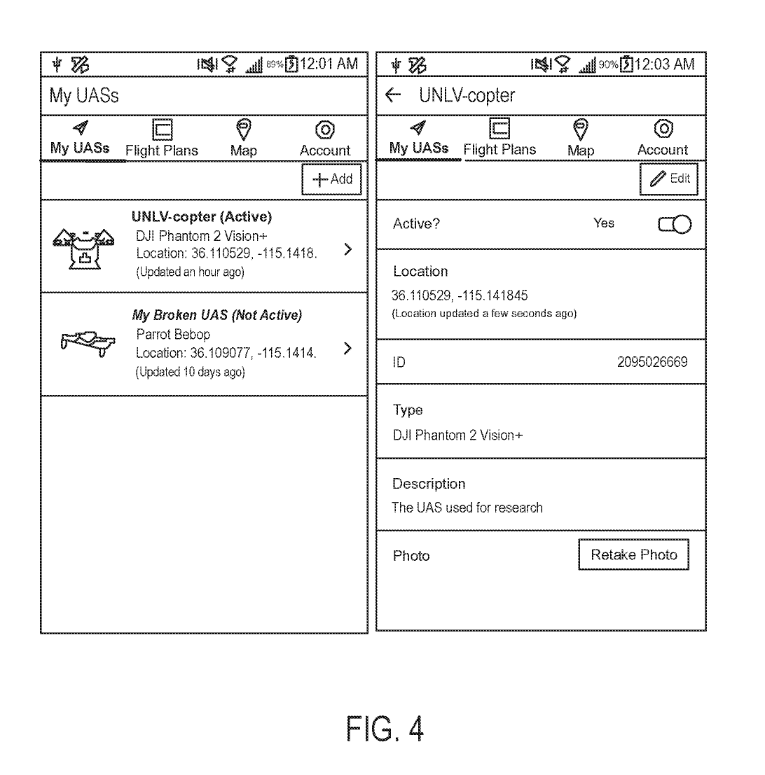

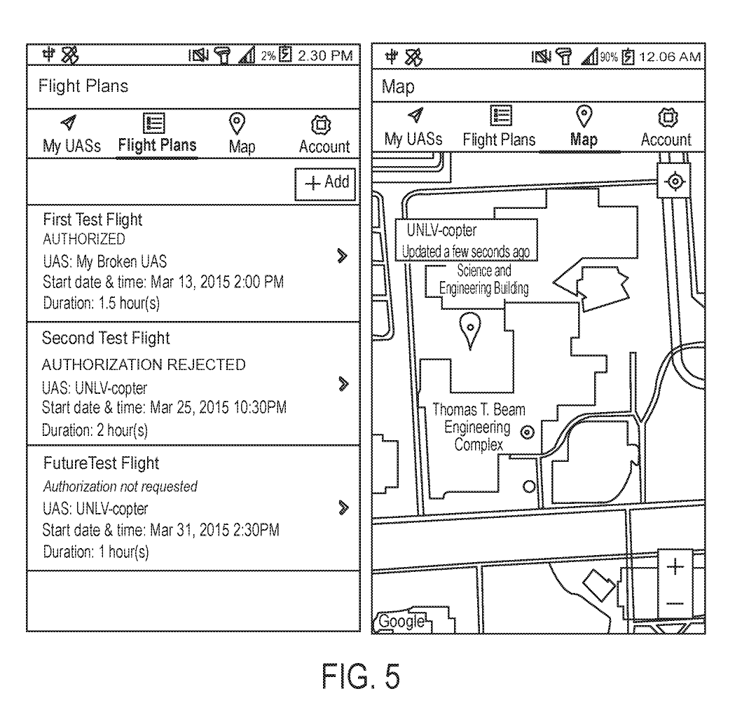

In referring to FIG. 3, FIG. 4, and FIG. 5, the operator can provide data to the UTM server 102 through an application provided through the UTM unit 104. For example, the operator can perform a registration process to generate the operator profile. Once the registration process is complete, subsequent authentication requests can reference the operator profile. When operating a UAS 110 for the first time, the operator can register the UAS 110 as shown in FIG. 3. For example, structural and/or model specifications of the UAS 110 and photos of the UAS 110 can be entered. An operator can have multiple UASs 110 that can be connected to a single UTM unit 104. In FIG. 4, the operator can browse through the multiple UASs 110, select the UAS 110 to be flown, and enter flight plan data and/or additional UAS 110 specifications. Referring to FIG. 5, once the operator profile and flight plan data have been entered, the flight approval status is delivered from the UTM server 102 and displayed on the UTM unit 104. The associated flight plan and the live location data are displayed on a map.

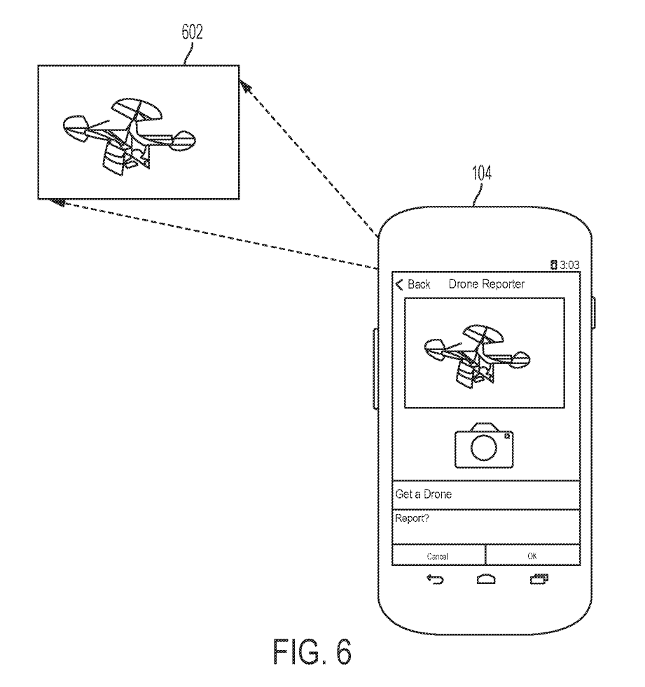

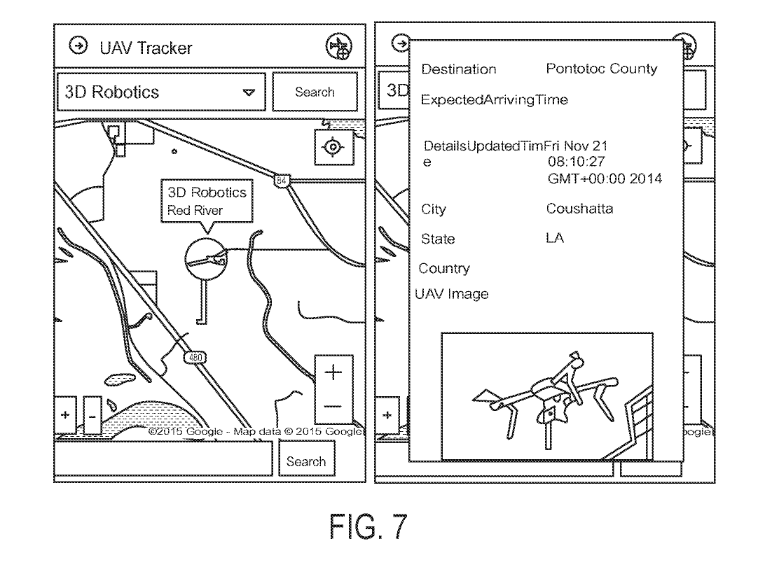

In another aspect, the UTM unit 104 can be further employed to manage UAS traffic by implementing a reporting application. As shown in FIG. 6, an operator can use the UTM unit 104 coupled to or embodied in a smart phone or device with picture taking capabilities. The UTM unit 104 can take a picture 602 of one or more other UASs 110 operating in the area. For example, when the operator spots an errant UAS 110, a photo 602 can be taken and sent to the UTM server 102 along with any other information applicable to identifying the other UASs 110 operating in the area. The photo 602 can be transmitted to the UTM server 102 along with a time and location. The location can be based on the location of the UTM unit 104. The reporting can be performed anonymously. The UTM server 102 can process the photo 602 and determine the type of UAS 110. Reported UAS activity data can augment the traffic data. As shown in FIG. 7, UAS activities can be stored by the UTM server 102 and made available for a user to browse UAS activities through the web interface of the UTM server 102, find UASs in the target region, and look at the photos 602.

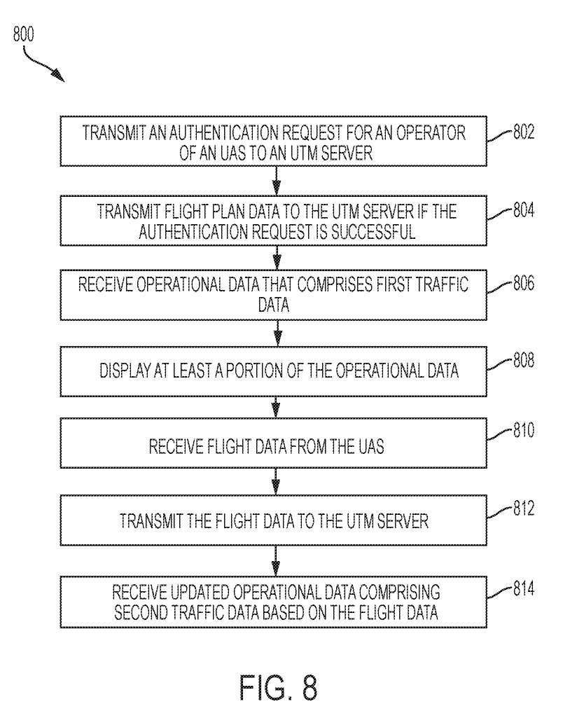

In an aspect, illustrated in FIG. 8, provided is a method 800 comprising transmitting an authentication request for an operator of an unmanned aircraft system (UAS) to an UAS Traffic Management (UTM) server at 802. In an aspect, the UTM server can comprise the UTM server 102. The method 800 can comprise transmitting flight plan data to the UTM server if the authentication request is successful at 804. The flight plan data can comprise a flight start time, a flight duration, and a flight path.

The method 800 can comprise receiving operational data that comprises first traffic data at 806. The first traffic data can comprise a location of one or more additional UASs within an area at a first time, a number of one or more additional UASs within an area at a first time, a location of one or more manned aircraft within an area at a first time, a number of one or more manned aircraft within an area at a first time, and combinations thereof. The operational data can further comprise weather data and privacy data. The first traffic data can be derived from flight plan data associated with one or more additional UASs in a geographic vicinity of the UAS and flight data associated with the one or more additional UASs.

The method 800 can comprise displaying at least a portion of the operational data at 808. The method 800 can comprise receiving flight data from the UAS at 810. The flight data can comprise global positioning data for the UAS, received during a matriculation of the UAS along a flight path. The method 800 can comprise transmitting the flight data to the UTM server at 812.

The method 800 can comprise receiving updated operational data comprising second traffic data based on the flight data at 814. The second traffic data can comprise a location of one or more additional UASs within an area at a second time, a number of one or more additional UASs within an area at a second time, a location of one or more manned aircraft within an area at a second time, a number of one or more manned aircraft within an area at a second time, and combinations thereof.

The method 800 can further comprise registering the operator with the UTM server. Registering the operator with the UTM server comprises transmitting an operator profile associated with the operator to the UTM server, the operator profile comprising operator personal identification, operator contact information, and one or more specifications for the UAS. The method 800 can further comprise reporting a presence of an additional UAS to the UTM server.

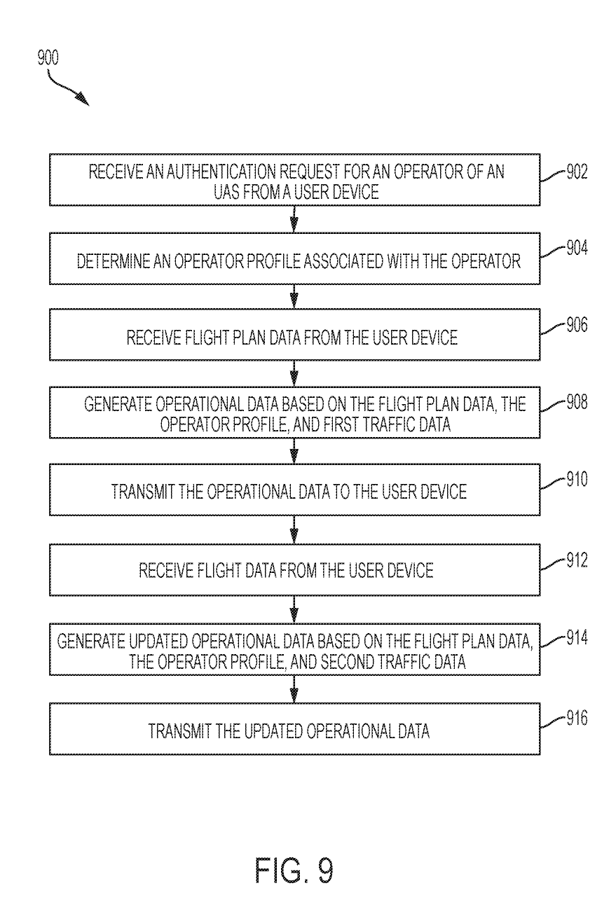

In an aspect, illustrated in FIG. 9, provided is a method 900 comprising receiving an authentication request for an operator of an unmanned aircraft system (UAS) from a user device at 902. In an aspect, the user device can comprise the UTM unit 104. The method 900 can comprise determining an operator profile associated with the operator at 904. The operator profile can comprise operator personal identification, operator contact information, and one or more specifications for the UAS.

The method 900 can comprise receiving flight plan data from the user device at 906. The flight plan data can comprise a flight start time, a flight duration, and a flight path.

The method 900 can comprise generating operational data based on the flight plan data, the operator profile, and first traffic data at 908. The operational data can comprise at least a portion of the first traffic data, weather data, privacy data, and combinations thereof. The first traffic data can comprise a location of one or more additional UASs within an area at a first time, a number of one or more additional UASs within an area at a first time, a location of one or more manned aircraft within an area at a first time, a number of one or more manned aircraft within an area at a first time, and combinations thereof.

The method 900 can comprise transmitting the operational data to the user device at 910.

The method 900 can comprise receiving flight data from the user device at 912. The flight data can comprise global positioning data for the UAS, received during a matriculation of the UAS along a flight path.

The method 900 can comprise generating updated operational data based on the flight data, the operator profile, and second traffic data at 914. The second traffic data can comprise a location of one or more additional UASs within an area at a second time, a number of one or more additional UASs within an area at a second time, a location of one or more manned aircraft within an area at a second time, a number of one or more manned aircraft within an area at a second time, and combinations thereof. One or more of the first traffic data and the second traffic data can be received from an air traffic control authority. The method 900 can comprise transmitting the updated operational data at 916. The updated operational data can comprise at least a portion of the second traffic data, weather data, privacy data, and combinations thereof.

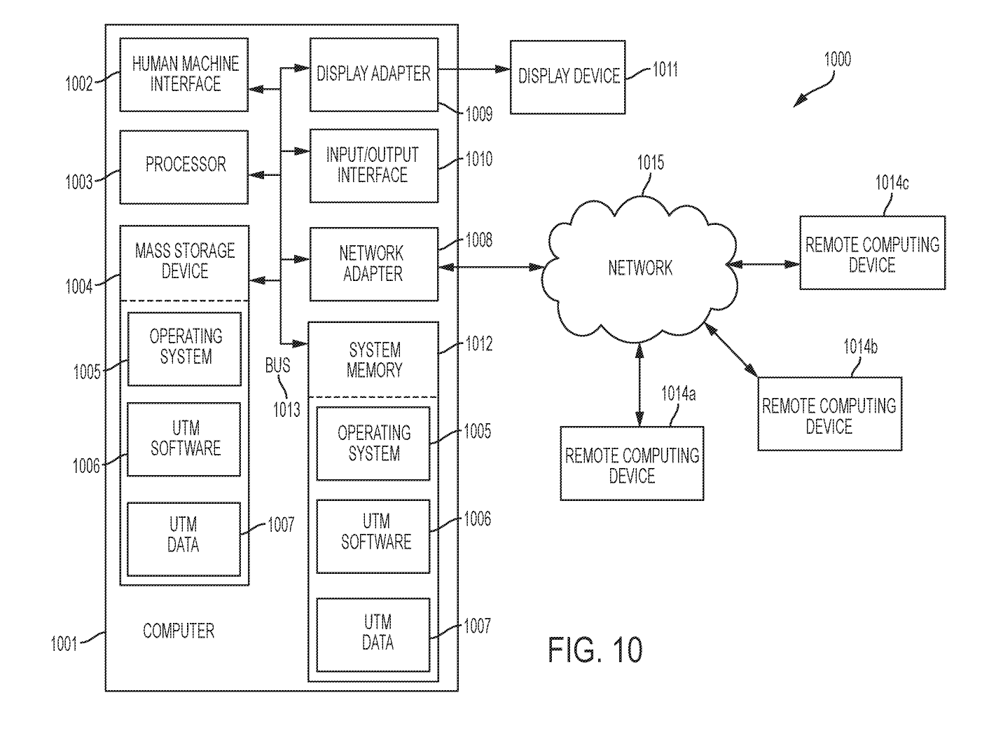

In an exemplary aspect, the methods and systems can be implemented on a computer 1001 as illustrated in FIG. 10 and described below. By way of example, UTM server 102 of FIG. 1 can be a computer 1001 as illustrated in FIG. 10. Similarly, the methods and systems disclosed can utilize one or more computers to perform one or more functions in one or more locations. FIG. 10 is a block diagram illustrating an exemplary operating environment 1000 for performing the disclosed methods. This exemplary operating environment 1000 is only an example of an operating environment and is not intended to suggest any limitation as to the scope of use or functionality of operating environment architecture. Neither should the operating environment 1000 be interpreted as having any dependency or requirement relating to any one or combination of components illustrated in the exemplary operating environment 1000.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 1001. The computer 1001 can comprise one or more components, such as one or more processors 1003, a system memory 1012, and a bus 1013 that couples various components of the computer 1001 including the one or more processors 1003 to the system memory 1012. In the case of multiple processors 1003, the computer 1001 can utilize parallel computing.

The bus 1013 can comprise one or more of several possible types of bus structures, such as a memory bus, memory controller, a peripheral bus, an accelerated graphics port, and a processor or local bus using any of a variety of bus architectures. The bus 1013, and all buses specified in this description can also be implemented over a wired or wireless network connection and one or more of the components of the computer 1001, such as the one or more processors 1003, a mass storage device 1004, an operating system 1005, UTM software 1006, UTM data 1007, a network adapter 1008, system memory 1012, an Input/Output Interface 1010, a display adapter 1009, a display device 1011, and a human machine interface 1002, can be contained within one or more remote computing devices 1014a,b,c at physically separate locations. In an aspect, the one or more remote computing devices 1014a,b,c can comprise one or more UTM units 104 and/or one or more UASs 110.

The computer 1001 typically comprises a variety of computer readable media. Exemplary readable media can be any available media that is accessible by the computer 1001 and comprises, for example and not meant to be limiting, both volatile and non-volatile media, removable and non-removable media. The system memory 1012 can comprise computer readable media in the form of volatile memory, such as random access memory (RAM), and/or non-volatile memory, such as read only memory (ROM). The system memory 1012 typically can comprise data such as UTM data 1007 and/or program modules such as operating system 1005 and UTM software 1006 that are accessible to and/or are operated on by the one or more processors 1003.

In another aspect, the computer 1001 can also comprise other removable/non-removable, volatile/non-volatile computer storage media. The mass storage device 1004 can provide non-volatile storage of computer code, computer readable instructions, data structures, program modules, and other data for the computer 1001. For example, a mass storage device 1004 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1004, including by way of example, an operating system 1005 and UTM software 1006. One or more of the operating system 1005 and UTM software 1006 (or some combination thereof) can comprise program modules and the UTM software 1006. UTM data 1007 can also be stored on the mass storage device 1004. UTM data 1007 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1015.

The user can enter commands and information into the computer 1001 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1003 via a human machine interface 1002 that is coupled to the bus 1013, but can be connected by other interface and bus structures, such as a parallel port, game port, an IEEE 1394 Port (also known as a Firewire port), a serial port, network adapter 1008, and/or a universal serial bus (USB).

In yet another aspect, a display device 1011 can also be connected to the bus 1013 via an interface, such as a display adapter 1009. It is contemplated that the computer 1001 can have more than one display adapter 1009 and the computer 1001 can have more than one display device 1011. For example, a display device 1011 can be a monitor, an LCD (Liquid Crystal Display), light emitting diode (LED) display, television, smart lens, smart glass, and/or a projector. In addition to the display device 1011, other output peripheral devices can comprise components such as speakers (not shown) and a printer (not shown) which can be connected to the computer 1001 via Input/Output Interface 1010. Any step and/or result of the methods can be output in any form to an output device. Such output can be any form of visual representation, including, but not limited to, textual, graphical, animation, audio, tactile, and the like. The display 1011 and computer 1001 can be part of one device, or separate devices.

The computer 1001 can operate in a networked environment using logical connections to one or more remote computing devices 1014a,b,c. By way of example, a remote computing device 1014a,b,c can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1001 and a remote computing device 1014a,b,c can be made via a network 1015, such as a local area network (LAN) and/or a general wide area network (WAN). Such network connections can be through a network adapter 1008. A network adapter 1008 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1005 are illustrated herein as discrete blocks, although it is recognized that such programs and components can reside at various times in different storage components of the computing device 1001, and are executed by the one or more processors 1003 of the computer 1001. An implementation of UTM software 1006 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
transmitting an authentication request for an operator of an unmanned aircraft system (UAS) to an UAS Traffic Management (UTM) server;
transmitting flight plan data to the UTM server if the authentication request is successful;
receiving operational data that comprises first traffic data;
displaying at least a portion of the operational data;
receiving flight data from the UAS;
transmitting the flight data to the UTM server; and
receiving updated operational data comprising second traffic data based on the flight data.

2. The method of claim 1, further comprising registering the operator with the UTM server.

3. The method of claim 2, wherein registering the operator with the UTM server comprises transmitting an operator profile associated with the operator to the UTM server, the operator profile comprising operator personal identification, operator contact information, and one or more specifications for the UAS.

4. The method of claim 1, further comprising reporting a presence of an additional UAS to the UTM server.

5. The method of claim 1, wherein the flight plan data comprises a flight start time, a flight duration, and a flight path.

6. The method of claim 1, wherein the operational data further comprises weather data and privacy data.

7. The method of claim 1, wherein the first traffic data comprises a location of one or more additional UASs within an area at a first time, a number of one or more additional UASs within an area at a first time, a location of one or more manned aircraft within an area at a first time, a number of one or more manned aircraft within an area at a first time, and combinations thereof.

8. The method of claim 1, wherein the first traffic data is derived from flight plan data associated with one or more additional UASs in a geographic vicinity of the UAS and flight data associated with the one or more additional UASs.

9. The method of claim 1, wherein the flight data comprises global positioning data for the UAS, received during a matriculation of the UAS along a flight path.

10. The method of claim 1, wherein the second traffic data comprises a location of one or more additional UASs within an area at a second time, a number of one or more additional UASs within an area at a second time, a location of one or more manned aircraft within an area at a second time, a number of one or more manned aircraft within an area at a second time, and combinations thereof.

11. A method comprising:
receiving an authentication request for an operator of an unmanned aircraft system (UAS) from a user device;
determining an operator profile associated with the operator;
receiving flight plan data from the user device;
generating operational data based on the flight plan data, the operator profile, and first traffic data;
transmitting the operational data to the user device;
receiving flight data from the user device;
generating updated operational data based on the flight data, the operator profile, and second traffic data; and
transmitting the updated operational data.

12. The method of claim 11, wherein the flight plan data comprises a flight start time, a flight duration, and a flight path.

13. The method of claim 11, wherein the operator profile comprises operator personal identification, operator contact information, and one or more specifications for the UAS.

14. The method of claim 11, wherein the operational data comprises at least a portion of the first traffic data, weather data, privacy data, and combinations thereof.

15. The method of claim 11, wherein the flight data comprises global positioning data for the UAS, received during a matriculation of the UAS along a flight path.

16. The method of claim 11, wherein the first traffic data comprises a location of one or more additional UASs within an area at a first time, a number of one or more additional UASs within an area at a first time, a location of one or more manned aircraft within an area at a first time, a number of one or more manned aircraft within an area at a first time, and combinations thereof.

17. The method of claim 11, wherein the second traffic data comprises a location of one or more additional UASs within an area at a second time, a number of one or more additional UASs within an area at a second time, a location of one or more manned aircraft within an area at a second time, a number of one or more manned aircraft within an area at a second time, and combinations thereof.

18. The method of claim 11, wherein one or more of the first traffic data and the second traffic data are received from an air traffic control authority.

19. The method of claim 11, wherein the updated operational data comprises at least a portion of the second traffic data, weather data, privacy data, and combinations thereof.

20. An apparatus comprising:
a memory, configured for storing an operator profile, flight plan data, flight data, first traffic data, second traffic data, operational data, and updated operational data; and
a processor, coupled to the memory, configured for performing steps comprising,
receiving an authentication request for an operator of an unmanned aircraft system (UAS) from a user device,
determining an operator profile associated with the operator;
receiving flight plan data from the user device,
generating operational data based on the flight plan data, the operator profile, and first traffic data,
transmitting the operational data to the user device,
receiving flight data from the user device,
generating updated operational data based on the flight data, the operator profile, and second traffic data, and
transmitting the updated operational data.

21. The apparatus of claim 20, wherein the flight plan data comprises a flight start time, a flight duration, and a flight path.

22. The apparatus of claim 20, wherein the operator profile comprises operator personal identification, operator contact information, and one or more specifications for the UAS.

23. The apparatus of claim 20, wherein the operational data comprises at least a portion of the first traffic data, weather data, privacy data, and combinations thereof.

24. The apparatus of claim 20, wherein the flight data comprises global positioning data for the UAS, received during a matriculation of the UAS along a flight path.

25. The apparatus of claim 20, wherein the first traffic data comprises a location of one or more additional UASs within an area at a first time, a number of one or more additional UASs within an area at a first time, a location of one or more manned aircraft within an area at a first time, a number of one or more manned aircraft within an area at a first time, and combinations thereof.

26. The apparatus of claim 20, wherein the second traffic data comprises a location of one or more additional UASs within an area at a second time, a number of one or more additional UASs within an area at a second time, a location of one or more manned aircraft within an area at a second time, a number of one or more manned aircraft within an area at a second time, and combinations thereof.

27. The apparatus of claim 20, wherein one or more of the first traffic data and the second traffic data are received from an air traffic control authority.

28. The apparatus of claim 20, wherein the updated operational data comprises at least a portion of the second traffic data, weather data, privacy data, and combinations thereof.
